(19) United States
(12) Patent Application Publication
(10) Pub. No.: US 2026/0212126 A1
(43) Pub. Date: Jul. 23, 2026

(54) GENERATING CITATIONS FOR LARGE LANGUAGE MODEL (LLM) RESPONSES

(71) Applicant: Salesforce, Inc., San Francisco, CA (US)

(72) Inventors: Sitaram Asur, San Francisco, CA (US); Shubham Mehrotra, San Francisco, CA (US); Regunathan Radhakrishnan, San Francisco, CA (US)

(21) Appl. No.: 19/032,723

(22) Filed: Jan. 21, 2025

Related U.S. Application Data
(60) Provisional application No. 63/710,178, filed on Oct. 22, 2024.

(51) Int. Cl. G06F 40/30

(52) U.S. Cl. CPC G06F 40/30

(57) ABSTRACT

A computer-implemented method for generating citations for responses generated by a large language model (LLM). The method includes receiving a prompt from a user, sending the prompt to the LLM, receiving a response from the LLM, and receiving a context source description of the LLM response from a data service. The context source description includes an URL and an identifier corresponding to the LLM response. The method also includes segmenting the LLM response into semantic segments, and generating citation descriptor text strings corresponding to the segments. The text strings identify relevant portions of the context source description as source references for the segments. Accuracy of the source references are validated. The method further includes arranging the validated text strings in a citation reporting statement having a predetermined syntax and format based on the semantic segments, and returning the citation reporting statement to the user.

The present disclosure relates generally to the field of artificial intelligence, machine learning, and natural language processing, and in particular, to generating citations for large language model (LLM) responses.

### BACKGROUND

Large language models (LLMs) have become increasingly prevalent in generating human-like responses for various applications. These models, however, often lack transparency and accountability leading to issues of trust and explainability. Users and businesses struggle to verify the accuracy and sources of information provided by LLMs which can lead to misinformation and reduced confidence in AI-generated contents. Traditional methods of citation or source attribution or justifications for different parts of the generated responses are not well suited for dynamic and complex outputs of LLMs. This generally creates a significant gap in the industry's ability to validate and explain AI generated responses. Existing approaches are understood as either inefficient, inaccurate or cumbersome to implement, limiting their scalability in real world applications.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description explain the principles of implementations of the disclosed subject matter. No attempt is made to show structural details in more detail than can be necessary for a fundamental understanding of the disclosed subject matter and various ways in which it can be practiced.

FIG. 1A is a block diagram illustrating an example architecture diagram of a system for generating citations for responses generated by a large language model (LLM).

FIG. 1B is a block diagram illustrating an example standard view of a system for generating in-line citations in a non-LLM mode.

FIG. 1C is a block diagram illustrating an example standard view of a system for generating in-line citations in an LLM mode.

FIG. 1D is a block diagram illustrating an example standard view of a system for generating post-fix citations in an LLM mode.

FIG. 2 is a flow diagram illustrating a computer-implemented method for generating citations for responses generated by a large language model (LLM).

FIG. 3A is a block diagram illustrating an exemplary electronic device according to an example implementation.

FIG. 3B is a block diagram of an exemplary deployment environment according to an example implementation.

### DETAILED DESCRIPTION

Various aspects or features of this disclosure are described with reference to the drawings, wherein like reference numerals are used to refer to like elements throughout. In this specification, numerous details are set forth in order to provide a thorough understanding of this disclosure. It should be understood, however, that certain aspects of disclosure can be practiced without these specific details, or with other methods, components, materials, or the like. In other instances, well-known structures and devices are shown in block diagram form to facilitate describing the subject disclosure.

The proposed solution provides methods and systems for generating citations for LLM-based responses by segmenting an LLM-generated response into distinct semantic segments and attributing relevant citations, and sourcing context data from multiple data services, for each segment using either a second LLM or a non-LLM based approach. The proposed solution processes the context data, applies fuzzy matching or LLM based post-processing (validation) techniques and ensures citation accuracy. Further, this method enhances explainability and trust aspects of the LLM responses by providing clear accurate citations for each segment of the responses. By providing a flexible, scalable solution for citation generation, this system significantly enhances the accuracy and latency of LLM generated contents across various applications and industries.

In an aspect of the disclosed subject matter, a computer-implemented method is disclosed for generating citations for responses generated by a large language model (LLM), as disclosed herein. The computer-implemented method may include receiving an action request prompt from a user, and sending the action request prompt to the LLM. A response to the action request prompt, may be received from the LLM. A context source description of the LLM response may be received from a data service. The context source description may include a Uniform Resource Locator (URL) and an identifier numeral corresponding to the LLM response.

The computer-implemented method may also include segmenting the LLM response into a number of semantic segments. Further, citation descriptor text strings corresponding to the semantic segments may be generated. The citation descriptor text strings corresponding to the semantic segments may be generated by performing fuzzy matching using sentence embedding similarity or Rouge score corresponding to the semantic segments. The citation descriptor text strings may identify relevant portions of the context source description as source references for the semantic segments.

The computer-implemented method may further include validating an accuracy of the source references for the semantic segments in the citation descriptor text strings, and arranging the validated citation descriptor text strings in a citation reporting statement. The accuracy of the source references may be validated by using a second large language model (LLM) or by using a non-LLM resource.

The citation reporting statement may have a predetermined syntax and format based on the semantic segments. The citation reporting statement may be returned to the user.

The citation reporting statement may include a number of parts referring to corresponding semantic segments of the LLM response. The parts of the citation reporting statement may appear in-line with the corresponding semantic segments of the LLM response.

The citation reporting statement may refer to the entire text of the LLM response and may appear at the end of the entire text of the LLM response.

In an aspect of the disclosed subject matter, a non-transitory machine-readable storage medium is disclosed that provides instructions that, if executed by a processor, are configurable to cause said processor to perform operations and methods for generating citations for responses generated by a large language model (LLM), as disclosed herein.

In an aspect of the disclosed subject matter, a system is disclosed for generating citations for responses generated by a large language model (LLM). The system may include a computer processor configured to run a public cloud network digitally connected with the computer processor. The system may also include a non-transitory machine-readable storage medium that provides instructions that are configurable to cause the apparatus to perform any of the methods disclosed herein.

A large language model (LLM) is a type of artificial intelligence (AI) program that uses machine learning to predict and generate human language content. LLMs are typically trained on large amounts of data, such as internet-scale datasets with hundreds of billions of parameters. This training allows LLMs to learn the patterns and structures of language, and to understand context by tracking relationships in sequential data.

Fuzzy matching, also known as approximate string matching, is a machine learning and artificial intelligence technique that identifies similar but not identical elements in data sets. Fuzzy matching techniques are typically used to find approximate matches in data sets, even when words are misspelled, abbreviated, or omitted. Fuzzy matching techniques work by comparing the similarity between two strings of text and producing a similarity score. The higher the score, the more likely the strings are considered a match.

ROUGE Score (Recall-Oriented Understudy for Gisting Evaluation), is a set of metrics that evaluate the quality of machine-generated summaries and translations. A typical ROUGE model compares the generated text to a set of reference summaries or translations created by humans. The ROUGE score is a scalar value that ranges from 0 to 1, with higher scores indicating a stronger similarity between the generated text and the reference.

In the context of using artificial intelligence, machine learning, and in particular, large language model (LLM) responses for natural language processing, it may be desirable to cite the sources in different parts of the generated responses in order to improve trust in LLM generated responses. The citations may then be exposed in the user interface (UI) of different generative applications. Typically, the generation of citations may be accomplished either in an in-line citation generation method, e.g., by an LLM generating the response in the act of creating the response, or in a post-generation citation generation method, e.g., by a separate citation service that may use an LLM, or not, after generating a response.

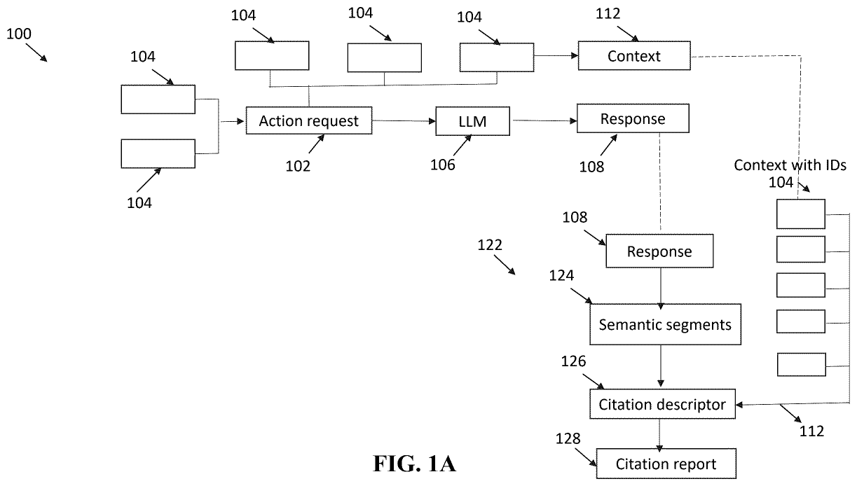

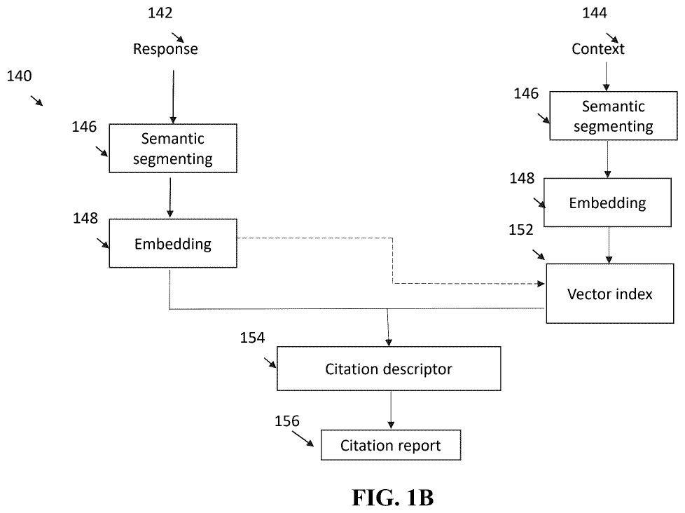

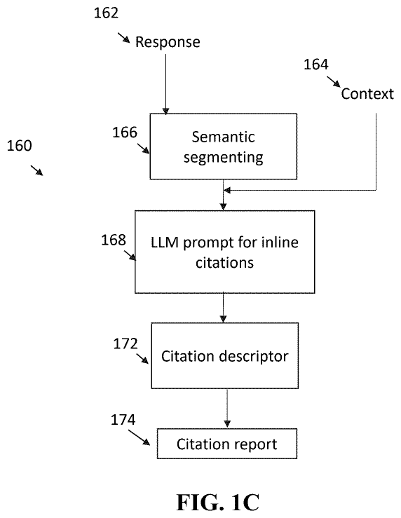

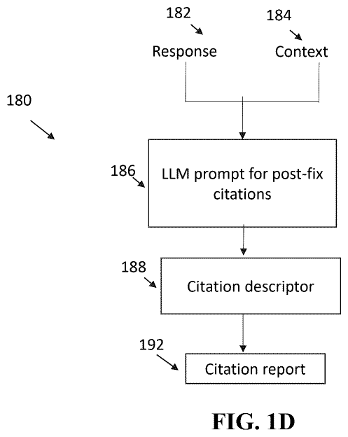

FIG. 1A is a block diagram illustrating an example architecture of a system 100 for generating citations for responses generated by a large language model (LLM). Referring to FIG. 1A, an example action request prompt 102 and several example data providers 104 may interact with an example LLM 106 and generate a response (also referred to as “generation”) 108. There may be multiple data providers 104 for the action request prompt including multiple retrievers, such as flow, Apex, Mergefield and the like. The data providers 104 may typically provide a URL (if applicable) along with an identification numeral (also referred to as “ID”). A querying application may be required to provide the context section with IDs and text from different data providers 104. For example, if a particular data service 104 provides five segments or so, the data service may need to provide corresponding IDs and URLs (where the UI may point to). Similarly, other data providers 104 may provide IDs corresponding to the texts they provide, as input, to the task prompt 102. The IDs and the URLs may typically be the text strings that may be cited back for different segments of the LLM response 108, in the outputs of the citation service.

Referring once more to FIG. 1A, operationally, the system 100 may receive an action request prompt 102 from a user (not shown), send the action request prompt 102 to the LLM 106, and receive a response 108 to the action request prompt 102 from the LLM 106. A context source description 112 corresponding to the LLM response 108 may be received from one or more of the data services 104. The context source description 112 may typically include a Uniform Resource Locator (URL) and an identifier numeral (ID) corresponding to the LLM response.

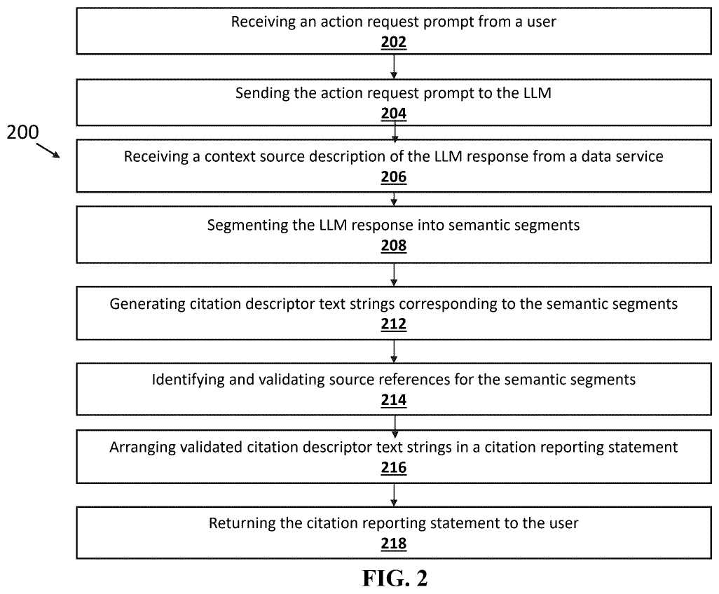

The system 100 may provide the LLM response 108 to a citation generation module 122 to generate the citations for the LLM response 108. The citation generation module 122 may segment the LLM response 108 into a number of semantic segments 124 and generate citation descriptor text strings 126 corresponding to the semantic segments 124. As an example, the citation descriptor text strings 126 corresponding to the semantic segments 124 may be generated by performing fuzzy matching technique using sentence embedding similarity or Rouge score corresponding to the semantic segments, as described in more details below in relation to the descriptions of FIGS. 1B, 1C, 1D, and 2.

Referring again to FIG. 1A, the citation descriptor text strings 126 may identify relevant portions of the context source description 112 as source references for the semantic segments 124. The citation generation module 122 may validate an accuracy of the source references for the semantic segments 124 in the citation descriptor text strings 126 and arrange the validated citation descriptor text strings 126 in one or more citation reporting statements 128. In an embodiment, the accuracy of the source references may be validated by using a second large language model (LLM). In an embodiment, the accuracy of the source references may be validated by using a non-LLM resource.

The citation reporting statements 128 may have a predetermined syntax and format based on the semantic segments. The citation reporting statements 128 may be returned to the user. As an example, the output citation for an LLM response input may be of the format “part 1 [c1][c2]. part 2[c3]. part 3[c4]”, with application JSON formatting conventions defining the exact expressions of c1, c2, c3, c4 and the like. In an example, the text in “part1. part2. part3” may be identical to the input generation. The process for generating citations may include providing support for the segments of the LLM response in the different types of contexts provided in the task prompt 102. In other words, the querying applications may require providing the response and the context containing text data from different data providers 104.

FIG. 1B is a block diagram illustrating an example system 140 for generating in-line citations in a non-LLM mode, typically deployed to generate sentence level citations through semantic search and segmentation. An example input may be: [generation, context] and an example output may be: part1[c1]. part2[c2]. part3 [c3]. All citations may be displayed next or near the source strings in the LLM response. This approach may be helpful for long responses and may be used with a single prompt and an LLM to provide citation JSONs at appropriate positions. This approach may require regenerating the original LLM response (FIGS. 1, 108) and therefore may require additional time to generate citation JSONs.

Referring to FIG. 1B, the system 140 may process an LLM response 142 and a corresponding context source description 144 to generate citations for the LLM response 142. The system 140 may segment the LLM response 142 into a number of semantic segments 146 and embed them in a vector space 148. The system 140 may further look up most similar contexts and integrate the contexts with a vector index 152 to generate post-processed citation descriptor text strings 154 corresponding to the semantic segments 146. The citation descriptor text strings 154 may identify relevant portions of the context source description 144 as source references for the semantic segments 146. The citation generation system 140 may validate an accuracy of the source references for the semantic segments 146 in the citation descriptor text strings 154 and arrange the validated citation descriptor text strings 154 in citation reporting statements 156. The citation reporting statements 156 may include a number of parts referring to the corresponding semantic segments 146 of the LLM response. The parts of the citation reporting statement 156 may appear in-line with the corresponding semantic segments 146 of the LLM response 142.

The advantage of this approach may be “specificity,” because the citations may be generated directly from the source segments of the texts provided by the context and no segment-level post processing may be involved. Further, the behavior of the system may be deterministic and there may not be much of back-and-forth LLM traffic, resulting in lower potential costs.

This approach may not necessarily use an LLM. Typically, the steps of implementation may include segmenting the LLM response into few segments using a semantic segmenter and performing fuzzy matching techniques for the segments using sentence embedding similarity (in case the generation is paraphrased) and/or Rouge score (for ngram overlaps). Further, the segments of the LLM response may be attributed to the segments of the context through post-processing and thresholding of this metric. This matching process may be repeated one context at a time.

This approach may typically be faster than an approach using an LLM if the context is not long. This approach may need additional tuning than the LLM based approach described below. A summary of example inputs and example citation outputs are provided below.

### Required Inputs

generation text: string
Context: formatted string with [context_ID: <context ID or URL>\n <context_string>]
mode: In-line
LLM: none
Input_type: <text>
Snippet_needed: <True/False>(default: True)
Snippet_postprocessing_needed: False

### Optional input for JSON Input_type

text_fields: <text fields within JSON that need citation>

### Citation Output

{
“citation_tagged_generation”: “generation part-1 [c1]. generation part-2[c2].”,
“c1”: {
   “context_id”: <id or URL>,
   “snippet”: <text within context supporting generation part-2>
   }
“c2”: {
   “context_id”: <id or URL>,
   “snippet”: <text within context supporting generation part-2>
   }
      }
FIG. 1C is a block diagram illustrating an example standard view of a system 160 for
generating in-line citations in an LLM mode, typically, to generate citations at a sentence level. An example input may be: [generation, context] and an example output may be: part 1[c1]. part2[c2]. part3 [c 3]. All citations may be displayed next or near the source strings in the LLM response. This approach may help in long responses, with a single prompt and may be used with LLM to provide citation JSONs at appropriate positions. This approach may require regenerating the original LLM response (FIGS. 1, 108) and therefore may require additional time to generate citation JSONs.

Referring to FIG. 1C, the system 160 may process an LLM response 162 and a corresponding context source description 164 to generate citations for the LLM response 162. The citation generation module 160 may segment the LLM response 162 into a number of semantic segments 166 and process one or more LLM prompts 168 for in-line citations to generate post-processed citation descriptor text strings 172 corresponding to the semantic segments 166. The citation descriptor text strings 172 may identify relevant portions of the context source description 164 as source references for the semantic segments 166. The citation generation system 160 may validate an accuracy of the source references corresponding to the semantic segments 166 in the citation descriptor text strings 172 and arrange the validated citation descriptor text strings 172 in citation reporting statements 174. The citation reporting statements 174 may include a number of parts referring to the corresponding semantic segments 166 of the LLM response. The parts of the citation reporting statement 174 may appear in-line with the corresponding semantic segments 166 of the LLM response 162.

The advantage of this approach may be “specificity” because the citations are generated directly from the source segments of the texts provided by the context and further, no segment-level post processing may be involved. This approach may be proficient enough to handle ill-formatted input and context data and may be useful when in-line sentence level citations may need to be displayed. This approach may also be useful for relatively longer responses (e.g., more than three sentences) and on occasions where there may be value in providing sentence level citations and the responses may be derived from multiple grounding sources. This approach may use post processing and may appropriate prompt tuning and may be quick to rollout.

Typically, the steps of implementing this method may include segmenting the LLM response into few segments using a semantic segmenter. Then, citations may be generated for the segments in the generated response, by using a prompt. The generated citation segments may have corresponding identification numerals of the context returned as well as the snippets that support the segment of the response. Subsequently, the citations for the segments may be post-processed. Usually, it may be verified that the citation snippets returned are reproduced verbatim from the context provided in the prompt (as the LLM sometimes may, undesirably, re-phrase it).

The LLM may also, for example, return character numbers for the starting character position and the ending character position of a snippet. After post-processing, the text strings “part 1[c1][c2]. part 2[c3]. part 3[c 4 ] may be returned with applicable JSONs for citations [c 1] [c2][c3][c4]”. The exact formats of how the segments (also referred to as “snippets”) may be represented in the citation JSON may be determined in any suitable manner. Further, the citation generating LLMs may be the in-house auto-evaluator as they might have been trained and used for generating citations as segments of the justification. A summary of example inputs, and example citation outputs is provided below.

### Required Inputs

generation text: string
Context: formatted string with [context_ID: <context ID or URL>\n <context_string>]
mode: In-line
LLM: <gpt3.5/gpt4o/in-house>
Input_type: <text>
Snippet_needed: <True/False>(default: True)
Snippet_postprocessing_needed: <True/False>(default: True)

### Citation Output

{
“Citation_tagged_generation”: “generation part-1 [c1]. generation part-2[c2].”,
“c1”: {
   “context_id”: <id or URL>,
   “snippet”: <text within context supporting generation part-2>
   }
“c2”: {
   “context_id”: <id or URL>,
   “snippet”: <text within context supporting generation part-2>
   }
      }

FIG. 1D is a block diagram illustrating an example standard view of a system 180 for generating post-fix citations in an LLM mode, typically, to generate citations for the entire LLM response at one time. This approach involves simplified LLM queries with no regeneration of semantic segments (also referred to as “snippets”) of the LLM response. As an example, the input may be: [generation, context] and the output may be: part 1.part2.part3 [c1][c2][c3]. All citations may be displayed at the end of response and usually they may not be linked one-to-one with the corresponding segments. This approach may be helpful for short responses, and may be used with a single prompt and an LLM to provide citation JSONs at the end.

Referring to FIG. 1D, the system 180 may process a LLM response 182 and a corresponding context source description 184 to generate citations for the LLM response 182. The citation generation module 180 may process one or more LLM prompts 186 for post-fix citations to generate post-processed citation descriptor text strings 188 corresponding to the entire LLM response 182. The citation generation system 180 may validate an accuracy of the source references for the citation descriptor text strings 188 and arrange the validated citation descriptor text string 188 in citation reporting statements 192. The citation reporting statements 192 may refer to the entire text of the LLM response 182 and may appear at the end of the entire text of the LLM response 182.

The advantage of this approach may be that there is no need to re-generate the LLM responses and only the citations [c1][c2][c3] need to be generated. This may be specifically useful when the citations need to be displayed only at the end of the LLM responses and not in-line with the LLM responses. This approach may be relatively quick to run and proficient in handling ill-formatted context data. Further, this approach may be quick to roll-out and useful when the LLM may be trusted to identify the most important parts of LLM response to cite. A summary of example inputs, and example citation outputs are provided below.

### Required Inputs

generation text: string
Context: formatted string with [context_id: <context_id or URL>\n <context_string>]mode: post-fix
LLM: <gpt3.5/gpt4o/in-house>
Input_type: <text>
Snippet_needed: <True/False>(default: True)

### Optional Input for Json Input_type:

text_fields: <text fields within JSON that need citation>

### Citation Output

{
“Citation_tagged_generation”: “generation part-1.generation part-2[c1][c2].”,
“c1”: {
   “context_id”: <id or URL>,
   “snippet”: <text within context supporting generation part-1>
   }
“c2”: {
   “context_id”: <id or Url>,
   “snippet”: <text within context supporting generation part-2>
   }
      }

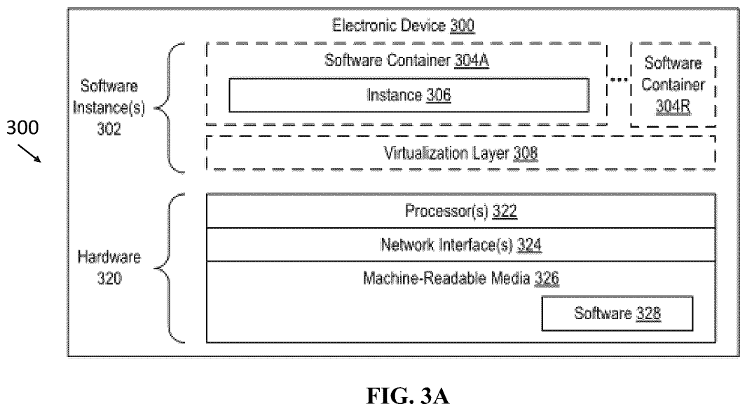

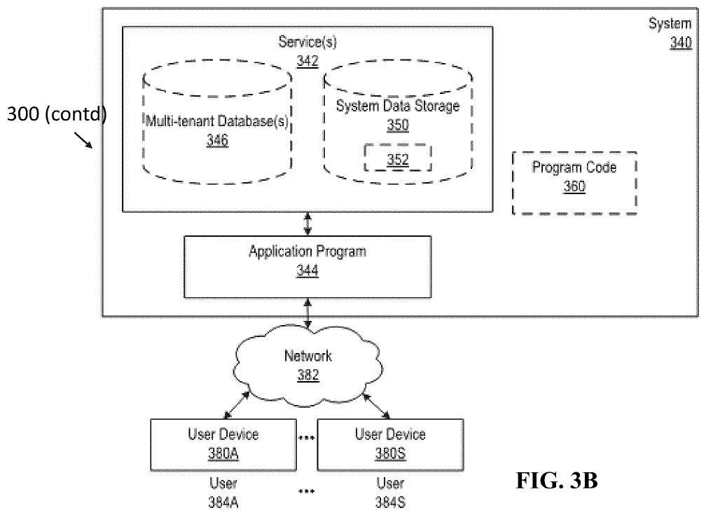

FIG. 2 is a flow diagram illustrating a computer-implemented method 200 for generating citations for responses generated by a large language model (LLM), as disclosed herein. The computer-implemented method 200 may be performed, for example, by a system as shown in FIG. 1A operating in conjunction with hardware as shown in FIGS. 3A and 3B.

The computer-implemented method 200 may include, as in step 202, receiving an action request prompt from a user, and sending the action request prompt to the LLM, as in step 204. At step 206, a response to the action request prompt, may be received from the LLM. At step 208, a context source description of the LLM response may be received from a data service. The context source description may include a Uniform Resource Locator (URL) and an identifier numeral corresponding to the LLM response.

The computer-implemented method 200 may include segmenting the LLM response into a number of semantic segments, as in step 212. At step 214, citation descriptor text strings corresponding to the semantic segments may be generated. The citation descriptor text strings may identify relevant portions of the context source description as source references for the semantic segments. The method 200 may further include validating an accuracy of the source references for the semantic segments in the citation descriptor text strings, and arranging the validated citation descriptor text strings in citation reporting statements, as in step 216.

The citation reporting statement may have a predetermined syntax and format based on the semantic segments. In an embodiment, the citation reporting statement may include a number of parts referring to corresponding semantic segments of the LLM response. The parts of the citation reporting statement may appear in-line with the corresponding semantic segments of the LLM response. In an embodiment, the citation reporting statement may refer to the entire text of the LLM response and may appear at the end of the entire text of the LLM response. At step 218, the citation reporting statement may be returned to the user.

Various implementations of the disclosed subject matter may provide improvements of several performance metrics, such as accuracy, embodied by correctness of the extracted segments, i.e., whether a claim actually occurs in the original response that is to be cited, embedding similarity, i.e., how well a snippet may be found in the context or how well the snippet and its corresponding claim may correlate with each other. Implementations disclosed herein may provide one or more improvements in latency, i.e., time taken to generate citations, and JSON accuracy, i.e., whether LLM responses are parse-able, citation output format so that the outputs are standardized and so that corresponding user interface (UI) components are format-compatible with the outputs. Embodiments disclosed herein may also provide citations in output formats that may be extensible to different conventions that citations may be expressed in, and further that may be consumed by the UI components without a lot of post-processing. In other words, all the post-processing may typically be possible within the citation service offered by the currently available solutions.

One or more parts of the above implementations may include software. Software is a general term whose meaning can range from part of the code and/or metadata of a single computer program to the entirety of multiple programs. A computer program (also referred to as a program) includes code and optionally data. Code (sometimes referred to as computer program code or program code) includes software instructions (also referred to as instructions). Instructions may be executed by hardware to perform operations. Executing software includes executing code, which includes executing instructions. The execution of a program to perform a task involves executing some or all of the instructions in that program.

An electronic device (also referred to as a device, computing device, computer, etc.) includes hardware and software. For example, an electronic device may include a set of one or more processors coupled to one or more machine-readable storage media (e.g., non-volatile memory such as magnetic disks, optical disks, read only memory (ROM), Flash memory, phase change memory, solid state drives (SSDs)) to store code and optionally data. For instance, an electronic device may include non-volatile memory (with slower read/write times) and volatile memory (e.g., dynamic random-access memory (DRAM), static random-access memory (SRAM)). Non-volatile memory persists code/data even when the electronic device is turned off or when power is otherwise removed, and the electronic device copies that part of the code that is to be executed by the set of processors of that electronic device from the non-volatile memory into the volatile memory of that electronic device during operation because volatile memory typically has faster read/write times. As another example, an electronic device may include a non-volatile memory (e.g., phase change memory) that persists code/data when the electronic device has power removed, and that has sufficiently fast read/write times such that, rather than copying the part of the code to be executed into volatile memory, the code/data may be provided directly to the set of processors (e.g., loaded into a cache of the set of processors). In other words, this non-volatile memory operates as both long term storage and main memory, and thus the electronic device may have no or only a small amount of volatile memory for main memory.

In addition to storing code and/or data on machine-readable storage media, typical electronic devices can transmit and/or receive code and/or data over one or more machine-readable transmission media (also called a carrier) (e.g., electrical, optical, radio, acoustical or other forms of propagated signals - such as carrier waves, and/or infrared signals). For instance, typical electronic devices also include a set of one or more physical network interface(s) to establish network connections (to transmit and/or receive code and/or data using propagated signals) with other electronic devices. Thus, an electronic device may store and transmit (internally and/or with other electronic devices over a network) code and/or data with one or more machine-readable media (also referred to as computer-readable media).

Software instructions (also referred to as instructions) are capable of causing (also referred to as operable to cause and configurable to cause) a set of processors to perform operations when the instructions are executed by the set of processors. The phrase “capable of causing” (and synonyms mentioned above) includes various scenarios (or combinations thereof), such as instructions that are always executed versus instructions that may be executed. For example, instructions may be executed: 1) only in certain situations when the larger program is executed (e.g., a condition is fulfilled in the larger program; an event occurs such as a software or hardware interrupt, user input (e.g., a keystroke, a mouse-click, a voice command); a message is published, etc.); or 2) when the instructions are called by another program or part thereof (whether or not executed in the same or a different process, thread, lightweight thread, etc.). These scenarios may or may not require that a larger program, of which the instructions are a part, be currently configured to use those instructions (e.g., may or may not require that a user enables a feature, the feature or instructions be unlocked or enabled, the larger program is configured using data and the program's inherent functionality, etc.). As shown by these exemplary scenarios, “capable of causing” (and synonyms mentioned above) does not require “causing” but the mere capability to cause. While the term “instructions” may be used to refer to the instructions that when executed cause the performance of the operations described herein, the term may or may not also refer to other instructions that a program may include. Thus, instructions, code, program, and software are capable of causing operations when executed, whether the operations are always performed or sometimes performed (e.g., in the scenarios described previously). The phrase “the instructions when executed” refers to at least the instructions that when executed cause the performance of the operations described herein but may or may not refer to the execution of the other instructions.

Electronic devices are designed for and/or used for a variety of purposes, and different terms may reflect those purposes (e.g., user devices, network devices). Some user devices are designed to mainly be operated as servers (sometimes referred to as server devices), while others are designed to mainly be operated as clients (sometimes referred to as client devices, client computing devices, client computers, or end user devices; examples of which include desktops, workstations, laptops, personal digital assistants, phones, wearables, augmented reality (AR) devices, virtual reality (VR) devices, mixed reality (MR) devices, etc.). The software executed to operate a user device (typically a server device) as a server may be referred to as server software or server code), while the software executed to operate a user device (typically a client device) as a client may be referred to as client software or client code. A server provides one or more services (also referred to as serves) to one or more clients.

The term “user” refers to an entity (typically, though not necessarily an individual person) that uses an electronic device. Software and/or services may use credentials to distinguish different accounts associated with the same and/or different users. Users can have one or more roles, such as administrator, programmer/developer, and end user roles. As an administrator, a user typically uses electronic devices to administer them for other users, and thus an administrator often works directly and/or indirectly with server devices and client devices. The term “consumer” refers to another computer service that is running the reusable software components of the system o FIG. 1.

FIG. 3A is a block diagram illustrating an electronic device 300 according to some example implementations. FIG. 3A includes hardware 320 including a set of one or more processor(s) 322, a set of one or more network interfaces 324 (wireless and/or wired), and machine-readable media 326 having stored therein software 328 (which includes instructions executable by the set of one or more processor(s) 322). The machine-readable media 326 may include non-transitory and/or transitory machine-readable media. Each of the previously described clients and server components may be implemented in one or more electronic devices 300. In one implementation: 1) each of the clients is implemented in a separate one of the electronic devices 300 (e.g., in end user devices where the software 328 represents the software to implement clients to interface directly and/or indirectly with server components (e.g., software 328 represents a web browser, a native client, a portal, a command-line interface, and/or an application programming interface (API) based upon protocols such as Simple Object Access Protocol (SOAP), Representational State Transfer (REST), etc.)); 2) server components is implemented in a separate set of one or more of the electronic devices 300 (e.g., a set of one or more server devices where the software 328 represents the software to implement the framework for providing additional security to protected fields in protected views); and 3) in operation, the electronic devices implementing the clients and server components would be communicatively coupled (e.g., by a network) and would establish between them (or through one or more other layers and/or other services) connections for submitting requests to server components and returning responses to the clients. Other configurations of electronic devices may be used in other implementations (e.g., an implementation in which the client and server components are implemented on a single one of electronic device 300).

During operation, an instance of the software 328 (illustrated as instance 306 and referred to as a software instance; and in the more specific case of an application, as an application instance) is executed. In electronic devices that use compute virtualization, the set of one or more processor(s) 322 typically execute software to instantiate a virtualization layer 308 and one or more software container(s) 304A-304R (e.g., with operating system-level virtualization, the virtualization layer 308 may represent a container engine (such as Docker Engine by Docker, Inc. or rkt in Container Linux by Red Hat, Inc.) running on top of (or integrated into) an operating system, and it allows for the creation of multiple software containers 304A-304R (representing separate user space instances and also called virtualization engines, virtual private servers, or jails) that may each be used to execute a set of one or more applications; with full virtualization, the virtualization layer 308 represents a hypervisor (sometimes referred to as a virtual machine monitor (VMM)) or a hypervisor executing on top of a host operating system, and the software containers 304A-304R each represent a tightly isolated form of a software container called a virtual machine that is run by the hypervisor and may include a guest operating system; with para-virtualization, an operating system and/or application running with a virtual machine may be aware of the presence of virtualization for optimization purposes). Again, in electronic devices where compute virtualization is used, during operation, an instance of the software 328 is executed within the software container 304A on the virtualization layer 308. In electronic devices where compute virtualization is not used, the instance 306 on top of a host operating system is executed on the “bare metal” electronic device 300. The instantiation of the instance 306, as well as the virtualization layer 308 and software containers 304A-304R if implemented, are collectively referred to as software instance(s) 302.

Alternative implementations of an electronic device may have numerous variations from that described above. For example, customized hardware and/or accelerators might also be used in an electronic device.

FIG. 3B is a block diagram of a deployment environment according to some example implementations. A system 340 includes hardware (e.g., a set of one or more server devices) and software to provide service(s) 342, including server components. In some implementations the system 340 is in one or more datacenter(s). These datacenter(s) may be: 1) first party datacenter(s), which are datacenter(s) owned and/or operated by the same entity that provides and/or operates some or all of the software that provides the service(s) 342; and/or 2) third-party datacenter(s), which are datacenter(s) owned and/or operated by one or more different entities than the entity that provides the service(s) 342 (e.g., the different entities may host some or all of the software provided and/or operated by the entity that provides the service(s) 342). For example, third-party datacenters may be owned and/or operated by entities providing public cloud services.

The system 340 is coupled to user devices 380A-380S over a network 382. The service(s) 342 may be on-demand services that are made available to one or more of the users 384A-384S working for one or more entities other than the entity which owns and/or operates the on-demand services (those users sometimes referred to as outside users) so that those entities need not be concerned with building and/or maintaining a system, but instead may make use of the service(s) 342 when needed (e.g., when needed by the users 384A-384S). The service(s) 342 may communicate with each other and/or with one or more of the user devices 380A-380S via one or more APIs (e.g., a REST API). In some implementations, the user devices 380A-380S are operated by users 384A-384S, and each may be operated as a client device and/or a server device. In some implementations, one or more of the user devices 380A-380S are separate ones of the electronic device 300 or include one or more features of the electronic device 300.

In some implementations, the system 340 is any generic network interface management system that uses web interfaces and includes server application components, client application components and a browser extension. The system and method provide for authenticating the end user via a browser extension that needs to be available in the intended user's web browser. The input to the system and method is the information about the views and its specific fields or any other part that is rendered and need to be protected, as provided by the application owner. Typical generic examples are Java clients and applications, Python based frameworks, libraries for client applications implementing the logic described above.

In some implementations, the system 340 is any generic network interface management system that uses web interfaces and includes server application components, client application components and a browser extension. The system and method provide for authenticating the end user via a browser extension that needs to be available in the intended user's web browser. The input to the system and method is the information about the views and its specific fields or any other part that is rendered and need to be protected, as provided by the application owner. Typical generic examples are Java clients and applications, Python based frameworks, libraries for client applications implementing the logic described above.

In some implementations, the system 340 is a multi-tenant system (also known as a multi-tenant architecture). The term multi-tenant system refers to a system in which various elements of hardware and/or software of the system may be shared by one or more tenants. A multi-tenant system may be operated by a first entity (sometimes referred to a multi-tenant system provider, operator, or vendor; or simply a provider, operator, or vendor) that provides one or more services to the tenants (in which case the tenants are customers of the operator and sometimes referred to as operator customers). A tenant includes a group of users who share a common access with specific privileges. The tenants may be different entities (e.g., different companies, different departments/divisions of a company, and/or other types of entities), and some or all of these entities may be vendors that sell or otherwise provide products and/or services to their customers (sometimes referred to as tenant customers). A multi-tenant system may allow each tenant to input tenant specific data for user management, tenant-specific functionality, configuration, customizations, non-functional properties, associated applications, etc. A tenant may have one or more roles relative to a system and/or service. For example, in the context of a customer relationship management (CRM) system or service, a tenant may be a vendor using the CRM system or service to manage information the tenant has regarding one or more customers of the vendor. As another example, in the context of Data as a Service (DAAS), one set of tenants may be vendors providing data and another set of tenants may be customers of different ones or all of the vendors'data. As another example, in the context of Platform as a Service (PAAS), one set of tenants may be third-party application developers providing applications/services and another set of tenants may be customers of different ones or all of the third-party application developers.

Multi-tenancy can be implemented in different ways. In some implementations, a multi-tenant architecture may include a single software instance (e.g., a single database instance) which is shared by multiple tenants; other implementations may include a single software instance (e.g., database instance) per tenant; yet other implementations may include a mixed model; e.g., a single software instance (e.g., an application instance) per tenant and another software instance (e.g., database instance) shared by multiple tenants.

In one implementation, the system 340 is a multi-tenant cloud computing architecture supporting multiple services, such as one or more of the following types of services: Customer relationship management (CRM); Configure, price, quote (CPQ); Business process modeling (BPM); Customer support; Marketing; Predictive Product Availability for Grocery Delivery; External data connectivity; Productivity; Database-as-a-Service; Data-as-a-Service (DAAS or DaaS); Platform-as-a-service (PAAS or PaaS); Infrastructure-as-a-Service (IAAS or IaaS) (e.g., virtual machines, servers, and/or storage); Analytics; Community; Internet-of-Things (IoT); Industry-specific; Artificial intelligence (AI); Application marketplace (“application store”); Data modeling; Security; and Identity and access management (IAM). For example, system 340 may include an application platform 344 that enables PAAS for creating, managing, and executing one or more applications developed by the provider of the application platform 344, users accessing the system 340 via one or more of user devices 380A-380S, or third-party application developers accessing the system 340 via one or more of user devices 380A-380S.

In some implementations, one or more of the service(s) 342 may use one or more multi-tenant databases 346, as well as system data storage 350 for system data 352 accessible to system 340. In certain implementations, the system 340 includes a set of one or more servers that are running on server electronic devices and that are configured to handle requests for any authorized user associated with any tenant (there is no server affinity for a user and/or tenant to a specific server). The user devices 380A-380S communicate with the server(s) of system 340 to request and update tenant-level data and system-level data hosted by system 340, and in response the system 340 (e.g., one or more servers in system 340) automatically may generate one or more Structured Query Language (SQL) statements (e.g., one or more SQL queries) that are designed to access the desired information from the multi-tenant database(s) 346 and/or system data storage 350.

In some implementations, the service(s) 342 are implemented using virtual applications dynamically created at run time responsive to queries from the user devices 380A-380S and in accordance with metadata, including: 1) metadata that describes constructs (e.g., forms, reports, workflows, user access privileges, business logic) that are common to multiple tenants; and/or 2) metadata that is tenant specific and describes tenant specific constructs (e.g., tables, reports, dashboards, interfaces, etc.) and is stored in a multi-tenant database. To that end, the program code 360 may be a runtime engine that materializes application data from the metadata; that is, there is a clear separation of the compiled runtime engine (also known as the system kernel), tenant data, and the metadata, which makes it possible to independently update the system kernel and tenant-specific applications and schemas, with virtually no risk of one affecting the others. Further, in one implementation, the application platform 344 includes an application setup mechanism that supports application developers'creation and management of applications, which may be saved as metadata by save routines. Invocations to such applications, including the framework for modeling heterogeneous feature sets, may be coded using Procedural Language/Structured Object Query Language (PL/SOQL) that provides a programming language style interface. Invocations to applications may be detected by one or more system processes, which manages retrieving application metadata for the tenant making the invocation and executing the metadata as an application in a software container (e.g., a virtual machine).

Network 382 may be any one or any combination of a LAN (local area network), WAN (wide area network), telephone network, wireless network, point-to-point network, star network, token ring network, hub network, or other appropriate configuration. The network may comply with one or more network protocols, including an Institute of Electrical and Electronics Engineers (IEEE) protocol, a 3rd Generation Partnership Project (3GPP) protocol, a 4^{th} generation wireless protocol (4G) (e.g., the Long Term Evolution (LTE) standard, LTE Advanced, LTE Advanced Pro), a fifth generation wireless protocol (5G), and/or similar wired and/or wireless protocols, and may include one or more intermediary devices for routing data between the system 340 and the user devices 380A-380S.

Each user device 380A-380S (such as a desktop personal computer, workstation, laptop, Personal Digital Assistant (PDA), smart phone, proficientwatch, wearable device, augmented reality (AR) device, virtual reality (VR) device, etc.) typically includes one or more user interface devices, such as a keyboard, a mouse, a trackball, a touch pad, a touch screen, a pen or the like, video or touch free user interfaces, for interacting with a graphical user interface (GUI) provided on a display (e.g., a monitor screen, a liquid crystal display (LCD), a head-up display, a head-mounted display, etc.) in conjunction with pages, forms, applications and other information provided by system 340. For example, the user interface device can be used to access data and applications hosted by system 340, and to perform searches on stored data, and otherwise allow one or more of users 384A-384S to interact with various GUI pages that may be presented to the one or more of users 384A-384S. User devices 380A-380S might communicate with system 340 using TCP/IP (Transfer Control Protocol and Internet Protocol) and, at a higher network level, use other networking protocols to communicate, such as Hypertext Transfer Protocol (HTTP), File Transfer Protocol (FTP), Andrew File System (AFS), Wireless Application Protocol (WAP), Network File System (NFS), an application program interface (API) based upon protocols such as Simple Object Access Protocol (SOAP), Representational State Transfer (REST), etc. In an example where HTTP is used, one or more user devices 380A-380S might include an HTTP client, commonly referred to as a “browser,” for sending and receiving HTTP messages to and from server(s) of system 340, thus allowing users 384A-384S of the user devices 380A-380S to access, process and view information, pages and applications available to it from system 340 over network 382.

In the above description, numerous specific details such as resource partitioning/sharing/duplication implementations, types and interrelationships of system components, and logic partitioning/integration choices are set forth in order to provide a more thorough understanding. Embodiments disclosed herein may be practiced without such specific details, however. In other instances, control structures, logic implementations, opcodes, means to specify operands, and full software instruction sequences have not been shown in detail since those of ordinary skill in the art, with the included descriptions, will be able to implement what is described without undue experimentation.

References in the specification to “one implementation,” “an implementation,” “an example implementation,” etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, and/or characteristic is described in connection with an implementation, one skilled in the art would know to affect such feature, structure, and/or characteristic in connection with other implementations whether or not explicitly described.

For example, the figure(s) illustrating flow diagrams sometimes refer to the figure(s) illustrating block diagrams, and vice versa. Whether or not explicitly described, the alternative implementations discussed with reference to the figure(s) illustrating block diagrams also apply to the implementations discussed with reference to the figure(s) illustrating flow diagrams, and vice versa. At the same time, the scope of this description includes implementations, other than those discussed with reference to the block diagrams, for performing the flow diagrams, and vice versa.

The detailed description and claims may use the term “coupled,” along with its derivatives. “Coupled” is used to indicate that two or more elements, which may or may not be in direct physical or electrical contact with each other, co-operate or interact with each other.

While the flow diagrams in the figures show a particular order of operations performed by certain implementations, such order is illustrative and not limiting (e.g., alternative implementations may perform the operations in a different order, combine certain operations, perform certain operations in parallel, overlap performance of certain operations such that they are partially in parallel, etc.).

While the above description includes several example implementations, the invention is not limited to the implementations described and can be practiced with modification and alteration within the spirit and scope of the appended claims. The description is thus illustrative instead of limiting.

What is claimed is:

1. A computer-implemented method for generating citations for responses generated by a large language model (LLM), the method comprising:
receiving an action request prompt from a user;
sending the action request prompt to the LLM;
receiving a response to the action request prompt, from the LLM;
receiving a context source description of the LLM response from a data service, the context source description comprising a Uniform Resource Locator (URL) and an identifier numeral corresponding to the LLM response;
segmenting the LLM response into a plurality of semantic segments;
generating citation descriptor text strings corresponding to the semantic segments, the citation descriptor text strings identifying relevant portions of the context source description as source references for the semantic segments;
validating an accuracy of the source references for the semantic segments in the citation descriptor text strings;
arranging the validated citation descriptor text strings in a citation reporting statement, the citation reporting statement having a predetermined syntax and format based on the semantic segments; and
returning the citation reporting statement to the user.

2. The method of claim 1, wherein the validating the accuracy of the source references comprises validating using a second large language model (LLM).

3. The method of claim 1, wherein the validating the accuracy of the source references comprises validating using a non-LLM resource.

4. The method of claim 3, wherein the generating citation descriptor text strings corresponding to the semantic segments comprises performing fuzzy matching using sentence embedding similarity or Rouge score corresponding to the semantic segments.

5. The method of claim 1, wherein the citation reporting statement comprises a plurality of parts referring to corresponding semantic segments of the LLM response.

6. The method of claim 5, wherein the plurality of parts of the citation reporting statement appear in-line with the corresponding semantic segments of the LLM response.

7. The method of claim 1, wherein the citation reporting statement refers to the entire text of the LLM response.

8. The method of claim 7, wherein the citation reporting statement appears at the end of the entire text of the LLM response.

9. A non-transitory machine-readable storage medium that provides instructions that, if executed by a processor, are configurable to cause said processor to perform operations comprising:
receiving an action request prompt from a user;
sending the action request prompt to the LLM;
receiving a response to the action request prompt, from the LLM;
receiving a context source description of the LLM response from a data service, the context source description comprising a Uniform Resource Locator (URL) and an identifier numeral corresponding to the LLM response;
segmenting the LLM response into a plurality of semantic segments;
generating citation descriptor text strings corresponding to the semantic segments, the citation descriptor text strings identifying relevant portions of the context source description as source references for the semantic segments;
validating an accuracy of the source references for the semantic segments in the citation descriptor text strings;
arranging the validated citation descriptor text strings in a citation reporting statement, the citation reporting statement having a predetermined syntax and format based on the semantic segments; and
returning the citation reporting statement to the user.

10. The non-transitory machine-readable storage medium of claim 9, wherein the validating the accuracy of the source references comprises validating using a second large language model (LLM).

11. The non-transitory machine-readable storage medium of claim 9, wherein the validating the accuracy of the source references comprises validating using a non-LLM resource.

12. The non-transitory machine-readable storage medium of claim 11, wherein the generating citation descriptor text strings corresponding to the semantic segments comprises performing fuzzy matching using sentence embedding similarity or Rouge score corresponding to the semantic segments.

13. The non-transitory machine-readable storage medium of claim 9, wherein the citation reporting statement comprises a plurality of parts referring to corresponding semantic segments of the LLM response.

14. The non-transitory machine-readable storage medium of claim 13, wherein the plurality of parts of the citation reporting statement appear in-line with the corresponding semantic segments of the LLM response.

15. The non-transitory machine-readable storage medium of claim 9, wherein the citation reporting statement refers to the entire text of the LLM response.

16. The non-transitory machine-readable storage medium of claim 15, wherein the citation reporting statement appears at the end of the entire text of the LLM response.

17. A system comprising:
a processor;
a cloud-based computing resource digitally connected with the processor;
a non-transitory machine-readable storage medium that provides instructions that, if executed by the processor, are configurable to cause the system to perform operations comprising:
receiving an action request prompt from a user;
sending the action request prompt to the LLM;
receiving a response to the action request prompt, from the LLM;
receiving a context source description of the LLM response from a data service, the context source description comprising a Uniform Resource Locator (URL) and an identifier numeral corresponding to the LLM response;
segmenting the LLM response into a plurality of semantic segments;
generating citation descriptor text strings corresponding to the semantic segments, the citation descriptor text strings identifying relevant portions of the context source description as source references for the semantic segments;
validating an accuracy of the source references for the semantic segments in the citation descriptor text strings;
arranging the validated citation descriptor text strings in a citation reporting statement, the citation reporting statement having a predetermined syntax and format based on the semantic segments; and
returning the citation reporting statement to the user.

18. The system of claim 17, wherein the validating the accuracy of the source references comprises validating using a second large language model (LLM).

19. The system of claim 17, wherein the validating the accuracy of the source references comprises validating using a non-LLM resource.

20. The system of claim 19, wherein the generating citation descriptor text strings corresponding to the semantic segments comprises performing fuzzy matching using sentence embedding similarity or Rouge score corresponding to the semantic segments.

21. The system of claim 17, wherein the citation reporting statement comprises a plurality of parts referring to corresponding semantic segments of the LLM response.

22. The system of claim 21, wherein the plurality of parts of the citation reporting statement appear in-line with the corresponding semantic segments of the LLM response.

23. The system of claim 17, wherein the citation reporting statement refers to the entire text of the LLM response.

24. The system of claim 23, wherein the citation reporting statement appears at the end of the entire text of the LLM response.
